(19) United States
(12) Patent Application Publication
(10) Pub. No.: US 2017/0339819 A1
(43) Pub. Date: Nov. 30, 2017

(54) INDEPENDENT GROUND ENGAGING TOOL DEPTH CONTROL

(71) Applicant: CNH Industrial Canada, Ltd., Saskatoon (CA)

(72) Inventors: Trevor Lawrence Kowalchuk, Saskatoon (CA); Russell Louis Altman, Saskatoon (CA)

(73) Assignee: CNH Industrial Canada, Ltd.

(21) Appl. No.: 15/167,591

(22) Filed: May 27, 2016

(51) Int. Cl. A01B 63/00; A01C 5/06; A01B 49/02; A01C 7/20; A01B 49/06

(52) U.S. Cl. CPC A01B 63/008; A01C 5/062; A01B 49/027; A01C 5/068; A01B 49/06; A01C 7/203

(57) ABSTRACT

A row unit includes a blade and a packer arm pivotally coupled to a packer support structure. The row unit also includes a packer wheel rotatably coupled to the packer arm, and configured to rotate across a soil surface to limit a penetration depth of the blade into the soil. The row unit further includes an actuator having a first portion rotatably coupled to the packer arm and a second portion rotatably coupled to the packer support structure, wherein the penetration depth of the blade is controlled by extending and contracting the actuator.

### BACKGROUND

The present disclosure relates to independently adjusting penetration depth of ground engaging tools of a seeding implement.

Generally, a seeding implement may be towed behind a work vehicle (e.g., a tractor) via a mounting bracket secured to a rigid frame of the seeding implement. The seeding implement typically includes multiple row units, each having at least one ground engaging tool. Each ground engaging tool typically includes a blade that forms a seeding path for seed deposition into the soil. The blade is used to break the soil to enable seed deposition. Seeds are typically deposited by a seed tube positioned proximate to the blade. The blade is followed by a packer wheel that packs the soil on top of the deposited seed. The packer wheel also serves to adjust a penetration depth of the blade within the soil. In certain configurations, the penetration depth of the blade is adjustable by varying a vertical position of the packer wheel relative to the blade.

In typical configurations, the packer wheel is pivotally coupled to a packer arm, and the packer arm is pivotally coupled to a packer support structure. Rotation of the packer arm relative to the packer support structure varies the vertical position of the packer wheel relative to the blade. In certain configurations, the packer arm includes a series of openings configured to receive a fastener. The openings are positioned such that the angle of the packer arm relative to the packer support structure may be varied by securing the fastener to a particular opening. However, removing the fastener from one opening, rotating the packer arm relative to the packer support structure, and securing the fastener within another opening is a time-consuming process. Furthermore, certain implements may include a large number of row units (e.g., greater than 50, 60, 70, 80, 90, or more). Because the row units are typically configured to maintain the same penetration depth, the duration of the depth adjustment process is multiplied by the number of row units coupled to the implement. Due to the large number of row units, it may be difficult to access many of the row units (e.g., because row units may be located in between other row units, in between structural elements of a frame coupled to multiple row units, etc.). Typically, adjusting each row unit includes using a tool for adjustment inside the frame, which may be inconvenient and provide limited space for tool use (e.g., operating a wrench). Consequently, reconfiguration of the seeding implement for a different penetration depth may result in large delays in seeding operations, thereby decreasing seeding efficiency.

### BRIEF DESCRIPTION

Certain embodiments commensurate in scope with the present disclosure are summarized below. These embodiments are not intended to limit the scope of the disclosure, but rather these embodiments are intended only to provide a brief summary of possible forms of the disclosure. Indeed, the disclosure may encompass a variety of forms that may be similar to or different from the embodiments set forth below.

In a first embodiment, a row unit includes a blade and a packer arm pivotally coupled to a packer support structure. The row unit also includes a packer wheel rotatably coupled to the packer arm, and configured to rotate across a soil surface to limit a penetration depth of the blade into the soil. The row unit further includes an actuator having a first portion rotatably coupled to the packer arm and a second portion rotatably coupled to the packer support structure, wherein the penetration depth of the blade is controlled by extending and contracting the actuator.

In a second embodiment, a seeding implement, including a tool bar and a plurality of row units coupled to the tool bar. Each row unit of the plurality of row units includes a packer support structure, a shank coupled to the packer support structure, and a packer arm pivotally coupled to the packer support structure. Each row unit also includes a packer wheel rotatably coupled to the packer arm, and configured to rotate across a soil surface to limit a penetration depth of a blade into the soil. Each row unit further includes an actuator having a first portion rotatably coupled to the packer arm and a second portion rotatably coupled to the packer support structure. Each row unit also includes the blade coupled to the shank, wherein the penetration depth of the blade is controlled by extending and contracting the actuator.

In a third embodiment, a row unit includes a blade and a packer wheel configured to rotate across a soil surface to limit a penetration depth of the blade into the soil. The row unit also includes an electrically powered linear actuator configured to control a vertical distance between the packer wheel and the blade.

### DRAWINGS

These and other features, aspects, and advantages of the present disclosure will become better understood when the following detailed description is read with reference to the accompanying drawings in which like characters represent like parts throughout the drawings, wherein:

FIG. 1 is a perspective view of a seeding implement including multiple row units, in accordance with an embodiment of the present disclosure;

FIG. 2 is a perspective view of a row unit that may be used on the seeding implement of FIG. 1, in accordance with an embodiment of the present disclosure;

FIG. 3 is a perspective view of another row unit that may be used on the seeding implement of FIG. 1, in accordance with an embodiment of the present disclosure;

FIG. 4 is a side view of the row unit of FIG. 2, illustrating operation of a blade and a packer wheel, in accordance with an embodiment of the present disclosure;

FIG. 5 is a block diagram of the row unit of FIG. 2, in accordance with an embodiment of the present disclosure;

FIG. 6 is a side view of the row unit of FIG. 3, illustrating operation of the blade and the packer wheel, in accordance with an embodiment of the present disclosure;

FIG. 7 is a side view of the row unit of FIG. 2, illustrating rotation of the packer arm, in accordance with an embodiment of the present disclosure; and

FIG. 8 is a side view of the row unit of FIG. 3, illustrating rotation of the packer arm, in accordance with an embodiment of the present disclosure

### DETAILED DESCRIPTION

The present disclosure provides a seeding implement depth adjustment mechanism configured to facilitate rapid reconfiguration of a ground engaging tool or opener for varying penetration depths. Specifically, the depth adjustment mechanism may be a powered or unpowered actuator that controls rotation of a packer arm relative to a packer support structure. For example, in one embodiment, a row unit includes a blade and a packer arm pivotally coupled to a packer support structure. The row unit also includes a packer wheel rotatably coupled to the packer arm, and configured to rotate across a soil surface to limit a penetration depth of the blade into the soil. The row unit further includes an actuator having a first portion rotatably coupled to the packer arm and a second portion rotatably coupled to the packer support structure, wherein the penetration depth of the blade is controlled by extending and contracting the actuator. Because penetration depth of a blade of the ground engaging tool may be adjusted remotely from the row unit or at multiple angles and positions at the row unit, the penetration depth may be controlled more efficiently than adjustment mechanisms that may only be adjusted from a single angle or position at the row unit.

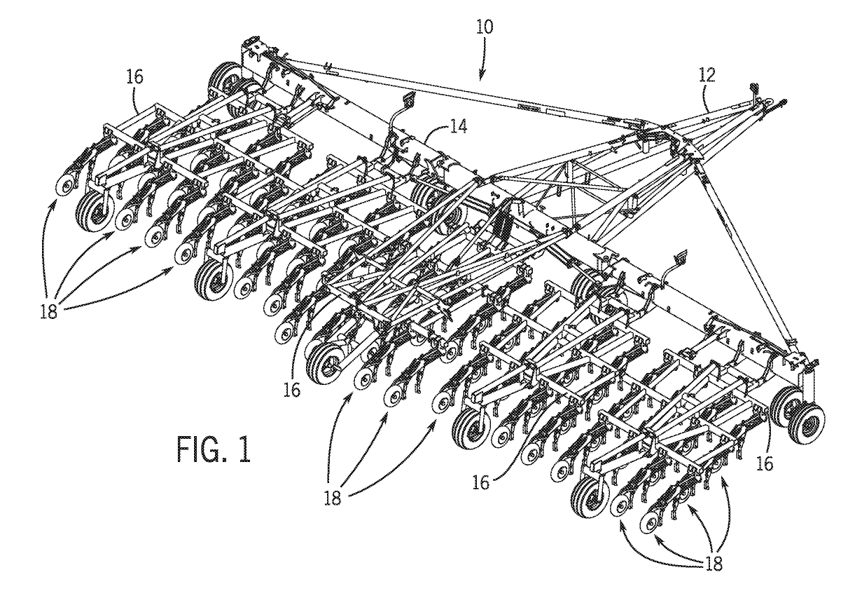

Turning now to the drawings, FIG. 1 is a perspective view of a seeding implement 10, in accordance with an embodiment of the present disclosure. The seeding implement 10 is configured to be towed behind a work vehicle, such as a tractor. The seeding implement 10 includes a tow bar assembly 12, which is shown in the form of an A-frame hitch assembly. The tow bar assembly 12 may include a hitch used to attach to an appropriate tractor hitch via a ball, clevis, or other coupling. The tow bar assembly 12 is coupled to a tool bar 14 which supports multiple tool frames 16. Each tool frame 16 includes multiple row units 18. As discussed in detail below, each row unit 18 includes an actuator configured to facilitate rapid reconfiguration of a ground engaging tool for varying penetration depth.

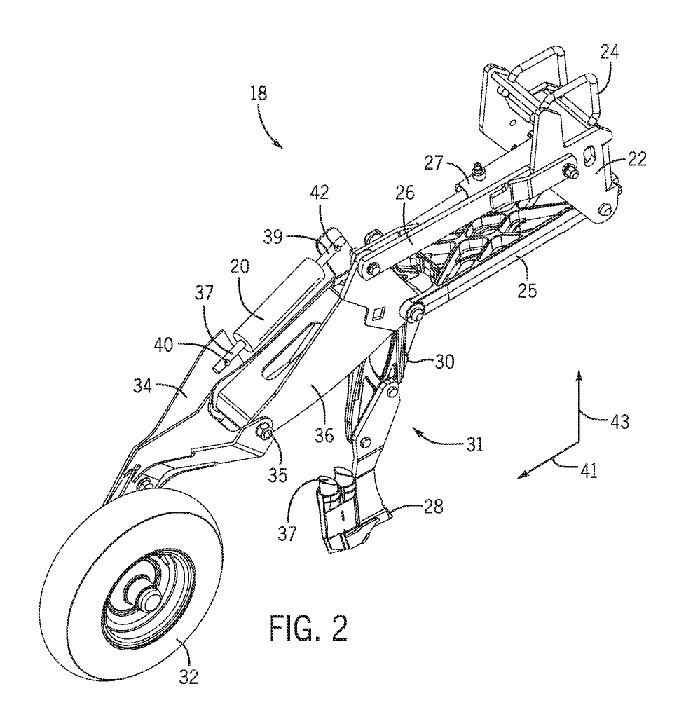

FIG. 2 is a perspective view of a row unit 18 that may be used on the seeding implement of FIG. 1, in accordance with an embodiment of the present disclosure. In the illustrated embodiment, the row unit 18 includes a powered actuator 20 configured to facilitate rapid reconfiguration of blade penetration depth. The row unit 18 also includes a frame support 22 and mounting brackets 24, which are configured to interface with a respective tool frame, thereby securing the row unit 18 to the respective tool frame. For instance, multiple row units 18 may be mounted in parallel along the respective tool frame to form a seeding unit. In the present configuration, the frame support 22, a first member 25, and a second member 26 form elements of a linkage. In some embodiments, the linkage may be a four bar linkage or a parallel linkage. Components of the row unit 18, such as the frame support 22, the mounting brackets 24, the first member 25, and the second member 26 may be formed from any suitable material, such as steel.

The row unit 18 includes a biasing device, such as the illustrated cylinder 27 (e.g., hydraulic or pneumatic piston-cylinder assembly). The cylinder 27 may be hydraulically coupled to a power supply that provides a flow of pressurized hydraulic fluid which displaces a piston rod extending from the cylinder 27. The cylinder 27 is attached to a shank 30 of a ground engaging tool 31 via a pin at the end of the piston rod. A blade 28 of the ground engaging tool 31 extends from the shank 30 and is configured to engage the soil. Contact force between the blade 28 and the soil establishes a moment about a shank pivot joint. This moment is resisted by force applied to the shank 30 by the cylinder 27. Furthermore, the linkage is configured to facilitate vertical movement of the respective tool frame, while maintaining the blade 28 at a desired penetration depth within the soil. As illustrated, the linkage is coupled to a packer support structure 36.

As illustrated, the frame support 22 is coupled to the packer support structure 36 via the first member 25 and the second member 26. The packer support structure 36 is coupled to the shank 30 of the ground engaging tool 31, and the blade 28 extends from the shank 30. The packer support structure 36 is pivotally coupled to a packer arm 34 that is coupled to a packer wheel 32. The blade 28 is configured to engage the soil. The blade 28 is used to break the soil to enable seed and/or fertilizer deposition. Seeds may be deposited into the soil via seed tube(s) 37 positioned proximate to the blade 28. The blade 28 is followed by the packer wheel 32 that packs the soil on top of the deposited seed. The packer wheel 32 also serves to adjust a penetration depth of the blade 28 within the soil. In certain configurations, the penetration depth of the blade 28 is adjustable by varying a vertical position of the packer wheel 32 relative to the blade 28.

As illustrated, the packer arm 34, including the packer wheel 32, is pivotally coupled to the packer support structure 36. A fastener 35 (e.g., a pin, bolt, or the like) disposed through openings within the packer arm 34 and the packer support structure 36 enables rotation of the packer arm 34 with respect to the packer support structure 36. Rotation of the packer arm 34 relative to the packer support structure 36 is controlled by the powered actuator 20. A first portion or end 37 of the powered actuator 20 is rotatably coupled to the packer arm 34 via a first rotatable fastener 40, and a second portion or end 39 of the powered actuator 20 is rotatably coupled to the packer support structure 36 via a second rotatable fastener 42. The first and second rotatable fasteners 40, 42 may include pins, bolts, rings, clips, and the like. In the illustrated embodiment, the powered actuator 20 is a linear actuator, in which the actuator extends and retracts along a straight line (e.g., a longitudinal axis 41). The powered actuator 20 may be any suitable type of powered actuator, such as an electrical actuator (e.g. a linear actuator, a piezoelectric actuator, an electromechanical actuator, etc.), a hydraulic actuator, a pneumatic actuator, and the like. Using the electrical actuator includes advantages such as simplicity, less cost, and self-locking features. For example, the electrical actuator, when compared to a hydraulic or pneumatic actuator, uses less wires and cables and is not prone to fluid leaks. Additionally, when the electrical actuator is used to set the blade 28 at a desired depth in the soil, the electrical actuator may stop or lock itself in the respective position when power is no longer supplied to the electrical actuator (as opposed to a hydraulic actuator, for example, that may constantly provide hydraulic fluid pressure to maintain the respective position).

Controlling the powered actuator 20 controls a penetration depth of the blade 28. For example, contracting the powered actuator 20 rotates the packer arm 34 upwardly (e.g., along a tranverse axis 43), such that a vertical distance between the packer wheel 32 and the blade 28 increases, increasing the penetration depth of the blade 28. Extending the powered actuator 20 rotates the packer arm 34 downwardly (e.g., along the tranverse axis 43), such that the vertical distance between the packer wheel 32 and the blade 28 decreases, decreasing the penetration depth of the blade 28. The powered actuator 20 may be controlled remotely from a location remote from the row unit 18. One or more control transfer devices, such as wires, cables, wireless communication devices, and the like, may communicatively couple the powered actuator 20 to one or more input devices that may be mounted in a suitable location (e.g., on the seeding implement). For example, an input device may be mounted on the tool bar or a tool frame of the seeding implement. In some embodiments, the input device may be located on the work vehicle (e.g., in a cab of a tractor towing the seeding implement). Each input device may control one or more powered actuators 20 of one or more row units 18. For example, an input device may control a set of row units 18, such that the powered actuators 20 of the set of row units 18 may be controlled by a single input device. In some embodiments, a single input device may control all row units 18 of the seeding implement, and may individually control each powered actuator 20 or groups of powered actuators 20. The input device may be any suitable device that may set a position of the powered actuator 20, such as a dial, switch, lever, button, and the like. In some embodiments, an operator may use the one or more input devices to adjust the position of the powered actuator 20 in between times of operation of the seeding implement, or even during operation. For example, if the one or more input devices are located in the cab of the tractor towing the seeding implement, the operator may set the blades 28 of the seeding implement at a desired depth while the seeding implement is in operation.

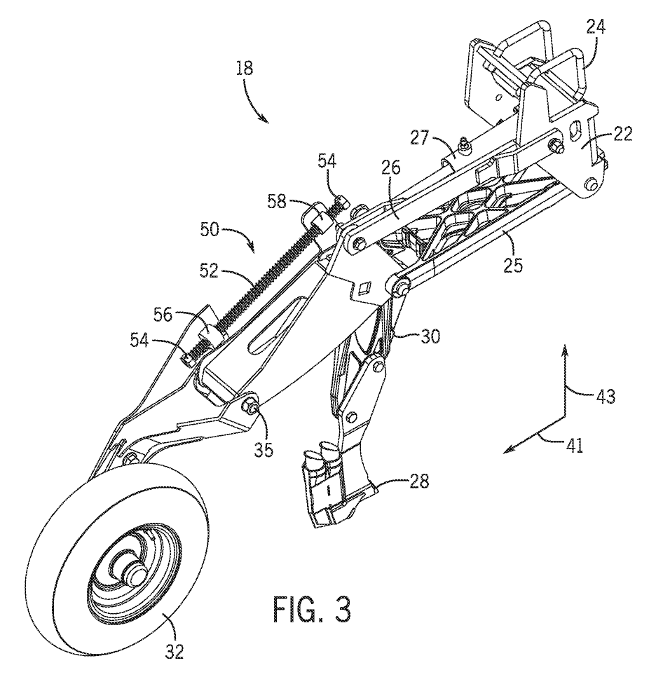

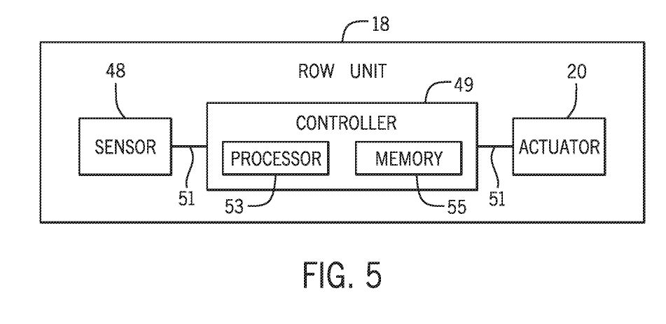

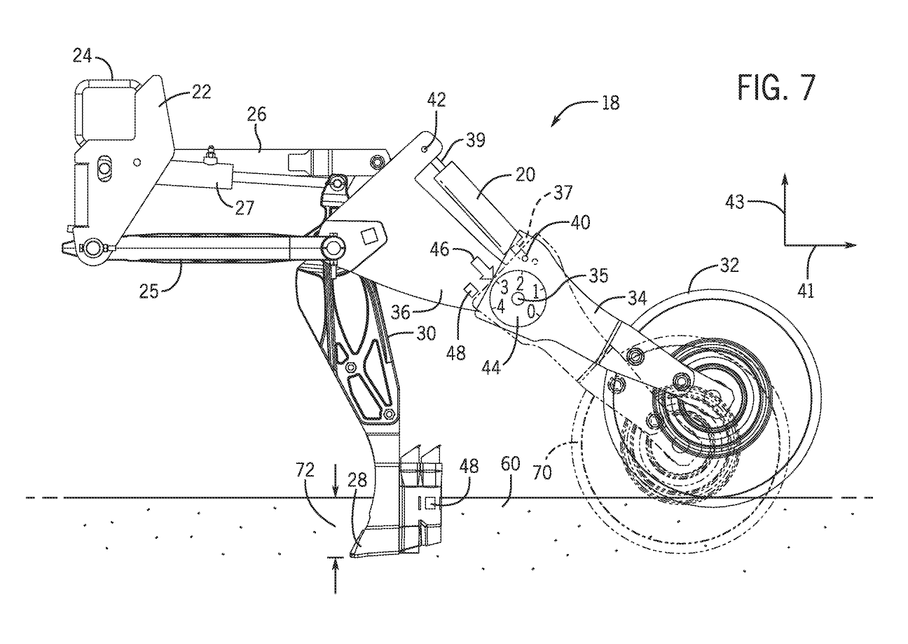

FIG. 3 is a perspective view of another row unit 18, in accordance with an embodiment of the present disclosure. In the illustrated embodiment, the row unit 18 includes an unpowered actuator 50 configured to facilitate rapid reconfiguration of blade penetration depth. Rotation of the packer arm 34 relative to the packer support structure 36 is controlled by the unpowered actuator 50. A first portion of the unpowered actuator 50 (e.g., first actuator fastener 56) is rotatably coupled to the packer arm 34 via the first rotatable fastener 40 (shown in FIGS. 5 and 7), and a second portion of the unpowered actuator 50 (e.g., second actuator fastener 58) is rotatably coupled to the packer support structure 36 via the second rotatable fastener 42 (shown in FIGS. 5 and 7).

The unpowered actuator 50 may be any suitable type of unpowered device that controls rotation of the packer arm 34 relative to the packer support structure 36. In the illustrated embodiment, the unpowered actuator 50 includes a threaded rod 52 with dual heads 54 that enable adjustment of the unpowered actuator 50. The heads 54 are configured to enable an operator to move the actuator fasteners 56, 58 relative to the threaded rod 52 via a suitable tool-engaging feature, such as any combination of a slotted recess, a cross-shaped (e.g., Philips) recess, an internal hex recess, a hex cap, and the like. As illustrated, the dual heads 54 each include a slotted recess and a hex cap. As such, the operator may use either a tool configured to engage with the slotted recess (e.g., a flathead screwdriver, a drill with a flathead bit, and the like) or a tool with a hex cap engagement (e.g., a wrench, a socket wrench, a drill with a socket bit, and the like) to adjust the unpowered actuator 50.

Rotating a head 54 of the unpowered actuator 50 enables controlling rotation of the packer arm 34 relative to the packer support structure 36. A first actuator fastener 56 of the unpowered actuator 50 is rotatably coupled to the packer arm 34 via the first rotatable fastener 40, and a second actuator fastener 58 of the unpowered actuator 50 is rotatably coupled to the packer support structure 36 via the second rotatable fastener 42. The first actuator fastener 56 may be a free fastener coupled to the threaded rod 52 that enables the threaded rod 52 to freely rotate without moving the free fastener 56 along the threaded rod 52, such that the position of the free fastener 56 is fixed relative to the threaded rod 52. The second actuator fastener 58 may be a threaded fastener (e.g., 58) coupled to the threaded rod 52 is threaded such that rotating the threaded rod 52 moves the threaded fastener 58 along the threaded rod 52. The free fastener may be any suitable fastener that enables the threaded rod 52 to rotate freely while holding the threaded rod 52 in place. The threaded fastener may be any suitable fastener that enables the threaded rod 52 to move the threaded fastener along the threaded rod 52 when the threaded rod 52 is rotated. For example, the free fastener and the threaded fastener may be trunnions, in which the free fastener is a non-threaded trunnion, and the threaded fastener is a threaded trunnion. Further references to the free fastener and the threaded fastener identify the free fastener as the first actuator fastener 56 and threaded fastener as the second actuator fastener 58. However, it should be noted that in alternative embodiments, the first actuator fastener 56 may be the threaded fastener and the second actuator fastener 58 may be the free fastener.

Adjusting the unpowered actuator 50 controls a penetration depth of the blade 28. For example, turning one head 54 of the dual heads 54 in a clockwise direction (and, correspondingly, the other dual head 54 in a counterclockwise direction) moves the free fastener 56 and the threaded fastener 58 on the threaded rod 52 closer to one another, thus rotating the packer arm 34 upwardly (e.g., along the tranverse axis 43). As a result, the vertical distance between the packer wheel 32 and the blade 28 increases, increasing the penetration depth of the blade 28. Turning the one head 54 in a counterclockwise direction (and, correspondingly, the other dual head 54 in a clockwise direction) moves the free fastener 56 and the threaded fastener 58 on the threaded rod 52 farther from one another, thus rotating the packer arm 34 downwardly (e.g., along the tranverse axis 43). As a result, the vertical distance between the packer wheel 32 and the blade 28 decreases, decreasing the penetration depth of the blade 28. Because the unpowered actuator 50 may be adjusted via either head 54, the penetration depth of the blade may be controlled from multiple positions relative to the row unit 18. That is, the penetration depth of the blade may be adjusted either from the front or the rear of the row unit 18 relative to the direction of travel. Moreover, enabling more than one type of tool to adjust the unpowered actuator 50 (e.g., via rotation of the heads 54) may enable multiple angles to control the penetration depth of the blade. For example, using a flathead screwdriver or a drill bit to adjust a head 54 of the threaded rod 52 may employ an angle (e.g., approximately zero degrees relative to the head 54) that is different from an angle (e.g., approximately 90 degrees relative to the head 54) when using a socket wrench. Enabling multiple positions and/or angles of adjustment may enable an operator to adjust the unpowered actuator 50 from outside of the tool frame 16. As a result, adjusting the unpowered actuator 50 from outside of the tool frame 16 may be more convenient, less time-consuming, and provide more space for tool use than adjusting an actuator from inside the tool frame 16. Because the penetration depth of the blade 28 may be controlled at multiple positions and/or angles, the penetration depth of each blade 28 of the seeding implement may be controlled more efficiently.

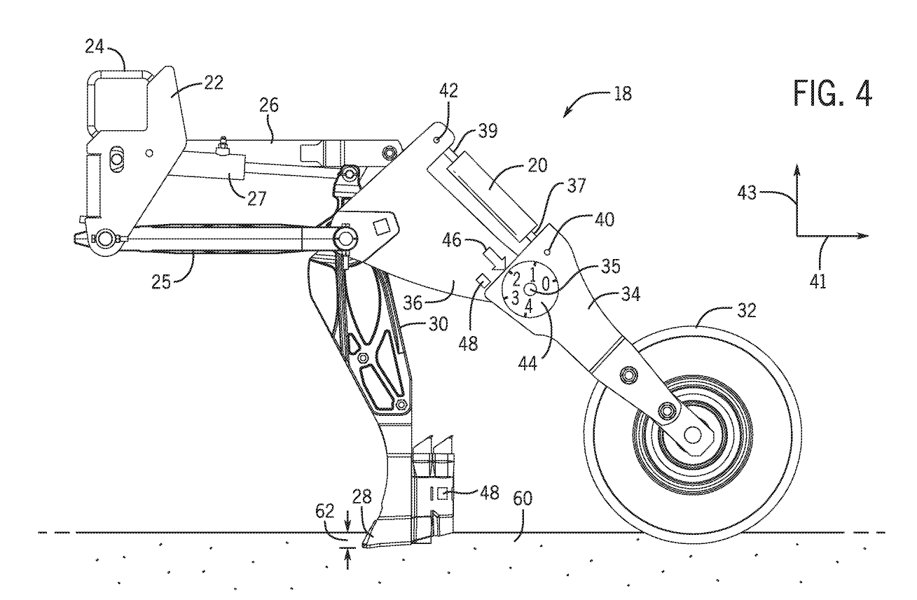

FIG. 4 is a side view of the row unit 18 of FIG. 2, illustrating operation of the blade 28 and the packer wheel 32, in accordance with an embodiment of the present disclosure. The blade 28 is configured to engage soil 60 at a particular depth 62. The depth 62 may be selected based on soil conditions, type of seeds, or environmental factors, among other considerations. As illustrated, the first end 37 of the powered actuator 20 is rotatably coupled to the packer arm 34 via the first rotatable fastener 40, and the second end 39 of the powered actuator 20 is rotatably coupled to the packer support structure 36 via the second rotatable fastener 42. Controlling the powered actuator 20 controls a penetration depth of the blade 28. For example, contracting the powered actuator 20 rotates the packer arm 34 upwardly (e.g., along the tranverse axis 43) relative to the packer support structure 36, such that the vertical distance between the packer wheel 32 and the blade 28 increases. Extending the powered actuator 20 rotates the packer arm 34 downwardly (e.g., along the tranverse axis 43) relative to the packer support structure 36, such that the vertical distance between the packer wheel 32 and the blade 28 decreases. Because the packer wheel 32 is configured to rotate across the top of the soil 60, varying the vertical position of the packer wheel 32 with respect to the blade 28 varies the penetration depth 62 of the blade 28 within the soil 60.

In the illustrated embodiment, the row unit 18 includes a depth indicator 44 that indicates a penetration depth of the blade 28 into the soil. The depth indicator 44 may be any suitable device that indicates the penetration depth of the blade 28, such as a dial, a strip or tape that includes depth marks, and the like. As illustrated, the depth indicator 44 is a dial that includes numbers indicating the penetration depth of the blade 28. An arrow 46 of the packer support structure 36 points to a position on the depth indicator 44, which is on the packer arm 34. The depth indicator 44 may enable the blade 28 to be accurately set at a target penetration depth in the soil.

FIG. 5 is a block diagram of the row unit 18 of FIG. 2, in accordance with an embodiment of the present disclosure. As illustrated, the row unit 18 includes a controller 49 that is configured to control the row unit 18. The row unit 18 includes a sensor 48 that outputs a signal indicative of the penetration depth of the blade 28 into the soil and/or a position of the packer arm 34 (e.g., relative to the packer support structure 36), e.g., via the one or more control transfer devices (e.g., 51) that communicatively couple the powered actuator 20 to an input device. For example, the controller 49 may receive the signal from the sensor 48 of each row unit 18 indicative of the depth of the blade 28 in the soil and/or the position of the packer arm 34. In some embodiments, the controller 49 may output another signal based at least in part on the signal from the sensor 48 to an output device (e.g., a display). The operator may control each powered actuator 20 via the controller 49 such that the respective blade 28 engages the soil at a target depth. In some embodiments, the operator may input the target depth for one or more of the blades 28 of one or more row units 18 of the seeding implement. After receiving a signal indicative of the target depth, the controller 49 or a controller of the seeding implement may then instruct one or more respective powered actuators 20 of the one or more row units 18 to engage the soil with the one or more blades 28 at the target depth. The output device may be located next to the input device that controls the powered actuator 20, or in some embodiments, be part of the same device as the input device, such that the same device accepts inputs (e.g., to control one or more powered actuators 20) and displays output information (e.g., the depth of the respective blade(s) 28.

In some embodiments, the controller 49 or a controller of the seeding implement may be communicatively coupled to a hydraulic work switch configured to stop the operator from changing the depth of the blade 28 while the seeding implement is in operation. Typically, the row units 18 of the seeding implement may be lifted (e.g., hydraulically, pneumatically, electrically, etc.) off the soil for adjustment. As an example, if the controller 49 receives a signal indicative of a hydraulic pressure measurement indicating that the row unit is on the soil, the controller 49 may engage (or disengage) the hydraulic work switch to stop the operator from changing the depth of the blade 28. In some embodiments, the work switch may be pneumatic, electric, or any other suitable device corresponding to lifting the row units 18 off the soil.

The controller 49 includes a processor 53 (e.g., a microprocessor) that may execute software, such as software for controlling the row unit 18. Moreover, the processor 53 may include multiple microprocessors, one or more “general-purpose” microprocessors, one or more special-purpose microprocessors, and/or one or more application specific integrated circuits (ASICS), or some combination thereof. For example, the processor 53 may include one or more reduced instruction set (RISC) processors. The controller 49 also includes a memory device 55 that may store information such as control software, look up tables, configuration data, etc. The memory device 55 may include a volatile memory, such as random access memory (RAM), and/or a nonvolatile memory, such as read-only memory (ROM). The memory device 55 may store a variety of information and may be used for various purposes. For example, the memory device 55 may store processor-executable instructions (e.g., firmware or software) for the processor 53 execute, such as instructions for controlling the row unit 18. In some embodiments, the memory device 55 is a tangible, non-transitory, machine-readable-medium that may store machine-readable instructions for the processor 53 to execute. The memory device 55 may include ROM, flash memory, a hard drive, or any other suitable optical, magnetic, or solid-state storage medium, or a combination thereof. The memory device 55 may store data, instructions, and any other suitable data.

In some embodiments, the positions of all of the blades 28 of the seeding implement may be synchronized by fully contracting or fully extending the corresponding powered actuator 20 before setting a depth of the blades 28 (e.g., via the controller 49). In this manner, accuracy of setting the depth of the blades 28 may be improved due to having the blades 28 at the same initial position before setting the depth. Because the penetration depth of each blade may be controlled at a location of easier access, as compared to a position associated with adjusting the location of a pin within a series of holes in the packer arm 34, the penetration depth may be controlled more efficiently.

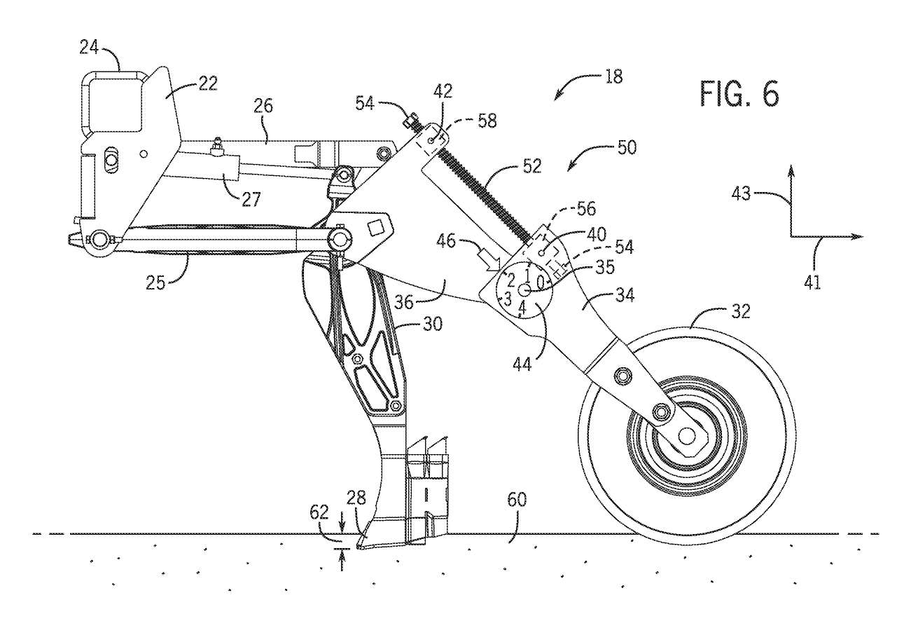

FIG. 6 is a side view of the row unit 18 of FIG. 3, illustrating operation of the blade 28 and the packer wheel 32, in accordance with an embodiment of the present disclosure. As illustrated, the free fastener 56 of the unpowered actuator 50 is rotatably coupled to the packer arm 34 via the first rotatable fastener 40, and the threaded fastener 58 of the unpowered actuator 50 is rotatably coupled to the packer support structure 36 via the second rotatable fastener 42. Adjusting the unpowered actuator 50 controls the penetration depth of the blade 28. For example, turning one head 54 of the dual heads 54 in a clockwise direction (and, correspondingly, the other dual head 54 in a counterclockwise direction) moves the free fastener 56 and the threaded fastener 58 on the threaded rod 52 closer to one another, thus rotating the packer arm 34 upwardly (e.g., along the tranverse axis 43). As a result, the vertical distance between the packer wheel 32 and the blade 28 increases, increasing the penetration depth of the blade 28. Turning the one head 54 in a counterclockwise direction (and, correspondingly, the other dual head 54 in a clockwise direction) moves the free fastener 56 and the threaded fastener 58 on the threaded rod 52 farther from one another, thus rotating the packer arm 34 downwardly (e.g., along the tranverse axis 43). Because the packer wheel 32 is configured to rotate across the top of the soil 60, varying the vertical position of the packer wheel 32 with respect to the blade 28 varies the penetration depth 62 of the blade 28 within the soil 60.

FIG. 7 is a side view of the row unit 18 of FIG. 2, illustrating rotation of the packer arm 34, in accordance with an embodiment of the present disclosure. The dashed lines represent the position 70 of the packer arm 34 as shown in FIG. 4. When the packer arm 34 is in the dashed line position 70, the powered actuator 20 is in a more extended configuration. As such, the blade 28 is positioned at a reduced penetration depth 62. Conversely, when the powered actuator 20 is in a more contracted configuration, the packer arm 34 is in the solid line position. Consequently, the blade 28 is positioned at an increased penetration depth 72 within the soil 60. As illustrated, the powered actuator 20 is in a more contracted configuration (compared to the powered actuator 20 of FIG. 4), thereby rotating the packer arm 34 to the illustrated solid line position and increasing the penetration depth 72 of the blade 28 within the soil 60.

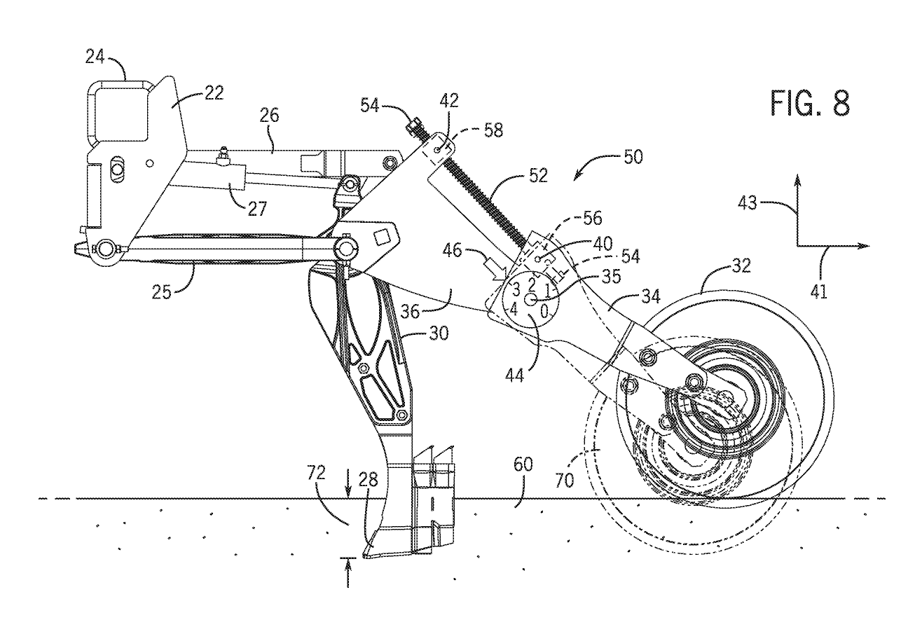

FIG. 8 is a side view of the row unit 18 of FIG. 3, illustrating rotation of the packer arm 34, in accordance with an embodiment of the present disclosure. The dashed lines represent the position 70 of the packer arm 34 as shown in FIG. 6. When the packer arm 34 is in the dashed line position 70, the free fastener 56 and the threaded fastener 58 on the threaded rod 52 are farther from one another. As such, the blade 28 is positioned at a reduced penetration depth 62. Conversely, when the free fastener 56 and the threaded fastener 58 on the threaded rod 52 are closer to one another, the packer arm 34 is in the solid line position. Consequently, when the blade 28 is positioned at an increased penetration depth 72 within the soil 60. As illustrated, the free fastener 56 and the threaded fastener 58 on the threaded rod 52 are closer to one another (compared to the unpowered actuator 50 of FIG. 4), thereby rotating the packer arm 34 to the illustrated solid line position and increasing the penetration depth 72 of the blade 28 within the soil 60.

While only certain features of the present disclosure have been illustrated and described herein, many modifications and changes will occur to those skilled in the art. It is, therefore, to be understood that the appended claims are intended to cover all such modifications and changes as fall within the true spirit of the present disclosure.

The techniques presented and claimed herein are referenced and applied to material objects and concrete examples of a practical nature that demonstrably improve the present technical field and, as such, are not abstract, intangible or purely theoretical. Further, if any claims appended to the end of this specification contain one or more elements designated as “means for [perform]ing [a function] . . . ” or “step for [perform]ing [a function] . . . ”, it is intended that such elements are to be interpreted under 35 U.S.C. 112(f). However, for any claims containing elements designated in any other manner, it is intended that such elements are not to be interpreted under 35 U.S.C. 112(f).

1. A row unit, comprising:
a blade;
a packer arm pivotally coupled to a packer support structure;
a packer wheel rotatably coupled to the packer arm, and configured to rotate across a soil surface to limit a penetration depth of the blade into the soil; and
an actuator having a first portion rotatably coupled to the packer arm and a second portion rotatably coupled to the packer support structure;
wherein the penetration depth of the blade is controlled by extending and contracting the actuator.

2. The row unit of claim 1, wherein the first portion of the actuator is rotatably coupled to the packer arm via a first fastener, and the second portion of the actuator is rotatably coupled to the packer support structure via a second fastener.

3. The row unit of claim 1, wherein the actuator is powered.

4. The row unit of claim 3, wherein the actuator comprises an electrically powered linear actuator.

5. The row unit of claim 1, comprising a controller configured to receive a signal indicative of a target penetration depth of the blade in the soil and instruct the actuator based on the signal.

6. The row unit of claim 1, comprising at least one sensor that, in operation, outputs a signal indicative of the penetration depth of the blade into the soil, a position of the packer arm, or a combination thereof.

7. The row unit of claim 1, wherein the actuator comprises a threaded rod.

8. The row unit of claim 7, wherein the actuator comprises:
a first actuator fastener rotatably coupled to the packer arm and coupled to the threaded rod; and
a second actuator fastener rotatably coupled to the packer support structure and coupled to the threaded rod.

9. The row unit of claim 8, wherein one of the first and second actuator fasteners comprises a free fastener, wherein one of the first and second actuator fasteners comprises a threaded fastener.

10. The row unit of claim 9, wherein the free fastener is a non-threaded trunnion and the threaded fastener is a threaded trunnion.

11. A seeding implement, comprising:
a tool bar;
a plurality of row units coupled to the tool bar, wherein each row unit of the plurality of row units comprises:
a packer support structure;
a shank coupled to the packer support structure;
a packer arm pivotally coupled to the packer support structure;
a packer wheel rotatably coupled to the packer arm, and configured to rotate across a soil surface to limit a penetration depth of a blade into the soil; and
an actuator having a first portion rotatably coupled to the packer arm and a second portion rotatably coupled to the packer support structure; and
the blade coupled to the shank;
wherein the penetration depth of the blade is controlled by extending and contracting the actuator.

12. The seeding implement of claim 11, wherein the tool bar supports a plurality of tool frames, wherein each row unit of the plurality of row units is coupled to a tool frame of the plurality of tool frames, wherein each row unit is configured to be adjusted outside of a respective tool frame coupled to the row unit.

13. The seeding implement of claim 12, wherein the actuator comprises a threaded rod.

14. The seeding implement of claim 13, wherein the actuator comprises:
a first actuator fastener rotatably coupled to the packer arm and coupled to the threaded rod; and
a second actuator fastener rotatably coupled to the packer support structure and coupled to the threaded rod.

15. The seeding implement of claim 14, wherein one of the first and second actuator fasteners comprises a free fastener, wherein one of the first and second actuator fasteners comprises a threaded fastener.

16. The seeding implement of claim 15, wherein the free fastener is a non-threaded trunnion and the threaded fastener is a threaded trunnion.

17. A row unit, comprising:
a blade;
a packer wheel configured to rotate across a soil surface to limit a penetration depth of the blade into the soil; and
an electrically powered linear actuator configured to control a vertical distance between the packer wheel and the blade.

18. The row unit of claim 17, comprising at least one sensor that, in operation, outputs a signal indicative of the penetration depth of the blade into the soil, a position of the packer arm, or a combination thereof.

19. The row unit of claim 17, comprising a depth indicator configured to indicate a depth of the blade in the soil.

20. The row unit of claim 19, wherein the depth indicator comprises a numbered dial.
